(19) United States
(12) Patent Application Publication
(10) Pub. No.: US 2016/0030843 A1
(43) Pub. Date: Feb. 4, 2016

(54) UTILIZATION AND METHOD FOR ELECTRONIC GAMING OF COMPILATION OF GAME USER DATA FOR VIDEO ENTERTAINMENT

(71) Applicant: Marshall Quinn Byrne, Merced, CA (US)

(72) Inventor: Marshall Quinn Byrne, Merced, CA (US)

(73) Assignee: Marshall Quinn Byrne

(21) Appl. No.: 14/445,060

(22) Filed: Jul. 29, 2014

(51) Int. Cl. A63F 13/47; A63F 13/63

(52) U.S. Cl. CPC A63F 13/47; A63F 13/63

(57) ABSTRACT

Video games created and distributed have software that track decisions made by the user within the game and are uploaded via the Internet to a system (e.g. Playstation Network or Xbox Live, PC, iOS, Android) and the decisions are compiled on a server. This compilation is monitored and can view which decisions are made most frequently by each user per game-unit sold. This data is used to determine the path of a plot of a video that is created based on that statistical information, as well as music choice and characters.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### STATEMENT REGARDING PRIOR DISCLOSURES BY THE INVENTOR

Not Applicable

### BACKGROUND OF THE INVENTION

1. Field of the Invention

The following disclosure generally relates to electronic games and video content, more particularly, to a method for compiling electronic game user data (user actions within a game) and utilizing that data to directly influence the plot and screenplay of video content based on user actions.

2. Background Art

Currently there is no method for compiling information from users of electronic gaming media for use within video content media. The methods that exist for compiling user data are not used for creating new video content, only to help influence future changes to the electronic game by the video game company. As used herein, the term electronic game refers to any game that is played on an electronic device. These include, without limitation, console-consoled based games such as Xbox or Playstation, PC games intended for play on a computer, handheld games, games for mobile phones or PDA's, and the like. As used herein, the term video content refers to any and all pictures and sound that is consumed by an audience on any audio-visual device, including but not limited to televisions, computers, and mobile devices.

The electronic gaming market is becoming more consumer-specific. This means companies are creating games where the user is able to change the course of a game based on his/her deliberate decisions within the game. This type of game-play is popular with consumers because the course of the game is unique to each user. Being able to control the actions of a character within a game closely ties the user to the storyline and even the character itself It is as if the character in the game is an extension of the user because the user was able to control the actions of the character.

Conversely, while audio-visual entertainment is also made for consumption, the content is often entirely independent of consumer desires or decisions. While consumers can become connected to a character within a movie or video, it is not the same as having actually manipulated the decisions of the character as in electronic gaming. While the consumer feels empathy as they are watching the character within the video, there is a certain amount of disconnect because the user did not actually have a direct hand in the content of the video.

For example, when a computer developer creates an electronic console game, it's a stand-alone project. Furthermore, the concept of a video or multi-media adaptation of that game is usually separate and independent of the electronic game itself A movie adaptation of an electronic game will often not involve many of the people who worked on the electronic game. The movie adaptation also will not include any user-driven content, and instead is based off of the general plot of the electronic game with the movie content being created by a writer or producer. While this method for creating movies has proven successful at times, it still does nothing to intimately involve the consumer in the process of creating the video content. The examples above illustrate the lack of utilizing user data and feedback to create video content.

### BRIEF SUMMARY OF THE INVENTION

The invention described herein will allow for the mechanism by which an electronic game will service the video content in terms of user decisions. The electronic game and the subsequent video content are no longer mutually exclusive. While the electronic game and video content continue to remain separate entities, the gap between the two is being bridged by creating a mechanism for one (electronic game) to influence the other (video content) directly. This will provide users with a more intimate entertainment experience.

The following describes a process for retrieving user decisions at key points within a video game and then using that data to influence the plot of a screenplay of a video or movie to be created based on the game characters and decisions made by the users of the game. This tool can be applied to all electronic games in order to create a unique user-driven experience within the entertainment industry.

The method allows for consumers to make decisions regarding the actions of a character at key points within an electronic game, which are captured automatically and recorded. The steps include collecting the user decision (data), moving the data from the device to a server via the Internet, and subsequently retrieving and analyzing the data from the server. Analysis of the data will include determining the decisions that were made most frequently by users. The data will be used to create a video for the consumers to watch after they have played the game. This process allows for the user to be more intimately connected with the game and the entertainment process.

### BRIEF DESCRIPTION OF THE SEVERAL VIEWS OF THE DRAWING

FIG. 1 illustrates a method for creating an interactive entertainment environment for consumers. It details the entire process of the invention from user game purchase through video creation based on user decisions collected.

FIG. 2 illustrates the method for generating a report based on user decisions within a game.

### DETAILED DESCRIPTION OF THE INVENTION

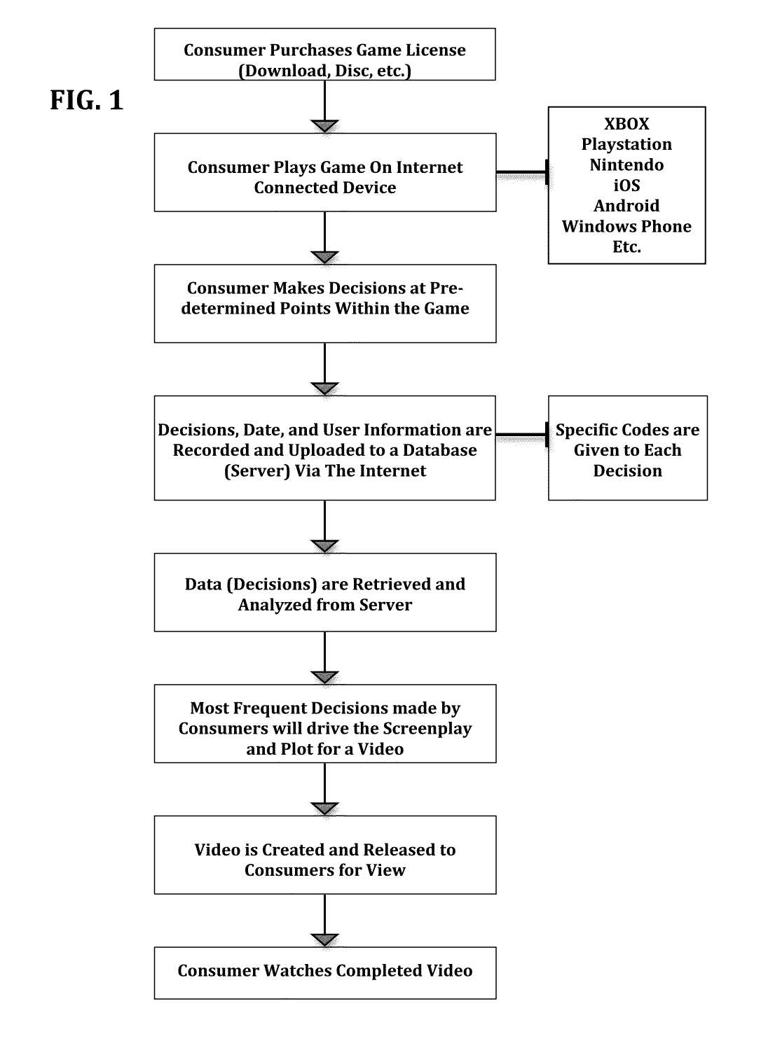

As seen in FIG. 1, a consumer purchases a game license and begins to play the game. At key pre-determined points in the game the user is required to make a decision. The decisions are to be made without the user knowing the decision is being recorded. Not advertising a decision is about to be recorded, or asking overtly for a decision to be made will allow the user to make unencumbered choices. Once a decision has been made the user will be allowed to continue on within the game. The decision the user makes at each pre-determined point within the game is recorded and submitted to a database (for example, a server) for analysis at a later time.

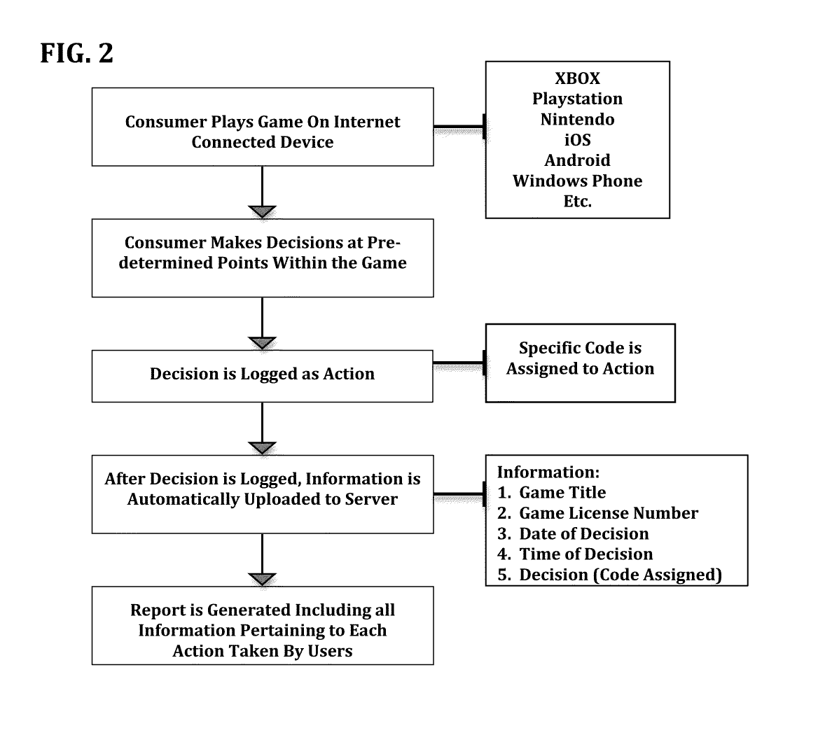

FIG. 2 illustrates the specific method for generating a report based on user decisions within a game. A consumer begins playing the game on an Internet connected device. Each time the user makes a decision at pre-determined points within the game, the decision is logged as an action. Only specific actions taken by the user are logged, and these actions are pre-determined by the game creator.

Electronic files, which are created each time a user makes a decision regarding an action within the game, have certain requirements. Each electronic file is given a unique name based on the game console type and the time and date the file was created. In addition, each electronic file contains a header consisting of the Game Title, Game License Number (a unique number given to each game license purchased), date of decision, time of decision, and decision made (action). Further, each decision (action) within the game is assigned a specific code that is used as an indicator of the decision made. This will allow for more efficient analysis once the game creators view the information.

Once the electronic files are pushed to the server from the game console, the electronic file is inserted into an SQL (Structured Query Language) server, or other type of database. The SQL server generates various types of reports, including but not limited to web reports and customizable reports in spreadsheet format. The reports will consist of at least two types of information. The first type of information identifies the Game Title and Game License Number along with the date and time of the decision. The second type of information consists of the decision (action) that was logged by the user at the specific pre-determined point within the game, identified by a code.

Once the data is retrieved and analyzed, the most frequent decisions made by users are used to influence the plot and screenplay of a video. For example, if most users chose to have the character enter a building by climbing through a window as opposed to the other options provided (walking through a doorway or climbing a ladder to the rooftop), the video will show the character entering the building through a window as most users decided.

The video is created and released to the consumer for view. Consumer watches the video.

I claim:

1. A method for prompting user decisions within an electronic game, the method comprising:
Presenting various options to the user in order to complete a pre-determined task within the game;
Requiring an option to be chosen by the user to proceed within the game.

2. The method of claim 1 wherein prompting the user to choose an option includes choosing from a variety of pre-determined options within a specific part of the game.

3. The method of claim 1 wherein the user is required to choose an option at a specific part of the game in order to move on within the game

4. A method for capturing information, including game title, game license number, date, time, and user decisions within an electronic game, the method comprising:
Generating a specific code to be given to each potential decision that can be transferred electronically;
Collecting the game title, game license number, date, time, and user's decisions in an electronic file;
Transferring the electronic file instantly from a game console to a server to facilitate retrieval at a later time and;
Retrieving the electronic files via report from a server.

5. The method of claim 4 wherein collecting the user decisions requires collecting game title, game license number, date, time, and user decisions, using a pre-determined code for identifying each user decision option and creating an electronic file recording this information.

6. The method of claim 4 wherein transferring the electronic file instantly from an electronic game console to a server includes initiating an upload of the electronic file through the console via the Internet.

7. The method of claim 4 wherein the retrieval of the electronic files from the server includes the server providing a variety of reports in a variety of formats for analysis.

8. A system for creating video content based on user decisions within an electronic game, the system comprising:
Means for receiving user information (game title, game license number, date, time, and user decisions made) within an electronic game;
Means for storing the user information (game title, game license number, date, time, and user decisions made) as electronic files within a game console;
Means for instantly transmitting electronic files from a game console to a server for retrieval at a later time, and;
Means for retrieving electronic files via a report from a server.

9. The system of claim 8 wherein the means for collecting the user decisions requires the means for collecting the game title, game license number, date, time and generating a code to identify each user decision option and the means of creating and storing an electronic file that contains each user information (game title, game license number, date, time, and decision made).

10. The system of claim 8 wherein the means for transferring the electronic file instantly from an electronic game console to a server includes the means of initiating an upload of the electronic file through the console.

11. The system of claim 8 wherein the means for the retrieval of the electronic files from the server includes the means for the server to provide a variety of reports in specific formats for analysis.

12. A method for developing video content based on user decisions from an electronic game, the method comprising:
Storing electronic files containing user decisions in a server;
Retrieving electronic files from the server;
Analyzing the electronic files to determine most frequent decisions made by users; and
Developing video content based on user decisions to create a more intimate user entertainment experience.

13. The method of claim 12 wherein storing electronic files includes storing electronic files that contain user information (game title, game license number, date, time, and user decisions made within the game).

14. The method of claim 12 wherein retrieving electronic files from a server includes retrieving information about user decisions within the game from the server.

15. The method of claim 12 wherein analyzing electronic files includes analyzing information about user decisions from the server.

16. The method of claim 12 wherein developing video content based on user decisions includes using the most frequent user decisions to drive the content of the video.
